(19) United States
(12) Patent Application Publication
(10) Pub. No.: US 2025/0237257 A1
(43) Pub. Date: Jul. 24, 2025

(54) SCREW WITH TOOL-LESS INSTALLATION FEATURES

(71) Applicant: Dell Products L.P., Round Rock, TX (US)

(72) Inventors: Megan Cherie WINGFIELD, Box Elder, SD (US); Bernard D. STRMISKA, Georgetown, TX (US); Julian Yu-Hao CHEN, Austin, TX (US); Brennan SEAL, Cypress, TX (US); Brooke PETERMAN, Austin, TX (US); Fabienne UMUTONIWASE, Fort Worth, TX (US); Anthony AIYEDUN, Garland, TX (US)

(73) Assignee: Dell Products L.P., Round Rock, TX (US)

(21) Appl. No.: 18/419,080

(22) Filed: Jan. 22, 2024

(51) Int. Cl. F16B 33/00; F16B 33/02

(52) U.S. Cl. CPC F16B 33/002; F16B 33/02

(57) ABSTRACT

A screw may comprise a head and a threaded cylindrical shaft mechanically coupled to the head such that an axis of the threaded cylindrical shaft extends from the head. The threaded cylindrical shaft may comprise a helical thread configured to sufficiently deform when a mechanical force drives the screw into a threaded insert due to mechanical interaction of the helical thread with a thread of the threaded insert and sufficiently engage with the thread of the threaded insert.

### TECHNICAL FIELD

The present disclosure relates in general to information handling systems, and more particularly to a screw with tool-less installation features.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Oftentimes, information handling systems and other information handling resources (e.g., storage devices, input/output devices, and other peripheral devices) are each manufactured in a modular form factor and may be configured to be disposed in a chassis configured to receive such modular components. Such a chassis and its component modular information handling systems and information handling resources typically include various rails, carriers, and other mechanical components allowing for a person to add and remove the modular information handling systems and information handling resources from the chassis.

In some instances, fasteners such as screws may be used to mechanically assemble components of modular information handling systems (e.g., hard drive carriers). However, assembling such components using conventional fasteners is time-consuming and often requires the use of tools keyed to the fasteners. Even current tool-less fasteners face challenges, such as difficulty in manufacturing, breakage during removal, and insufficient engagement with threaded inserts.

### SUMMARY

In accordance with the teachings of the present disclosure, the disadvantages and problems associated with tool-less mechanical screws have been reduced or eliminated.

In accordance with these and other embodiments of the present disclosure a screw may comprise a head and a threaded cylindrical shaft mechanically coupled to the head such that an axis of the threaded cylindrical shaft extends from the head. The threaded cylindrical shaft may comprise a helical thread configured to sufficiently deform when a mechanical force drives the screw into a threaded insert due to mechanical interaction of the helical thread with a thread of the threaded insert and sufficiently engage with the thread of the threaded insert.

In accordance with these and other embodiments of the present disclosure an information handling system may comprise an information handling resource, a carrier configured to mechanically couple to the information handling resource, and a screw for mechanically coupling the information handling resource to the carrier. The screw may comprise a head and a threaded cylindrical shaft mechanically coupled to the head such that an axis of the threaded cylindrical shaft extends from the head. The threaded cylindrical shaft may comprise a helical thread configured to sufficiently deform when a mechanical force drives the screw into a threaded insert due to mechanical interaction of the helical thread with a thread of the threaded insert and sufficiently engage with the thread of the threaded insert.

In accordance with these and other embodiments of the present disclosure a method may comprise mechanically coupling a head of a screw to a threaded cylindrical shaft of the screw such that an axis of the threaded cylindrical shaft extends from the head, the threaded cylindrical shaft comprising a helical thread configured to sufficiently deform when a mechanical force drives the screw into a threaded insert due to mechanical interaction of the helical thread with a thread of the threaded insert and sufficiently engage with the thread of the threaded insert.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a perspective view of an example screw with tool-less installation features, in accordance with embodiments of the present disclosure;

FIGS. 2A and 2B illustrate plan views of an example component carrier including example screws with tool-less installation features installed in the example component carrier, in accordance with embodiments of the present disclosure; and

FIG. 3 illustrates a perspective view of an example component carrier including example screws with tool-less installation features installed in the example component carrier, in accordance with embodiments of the present disclosure.

### DETAILED DESCRIPTION

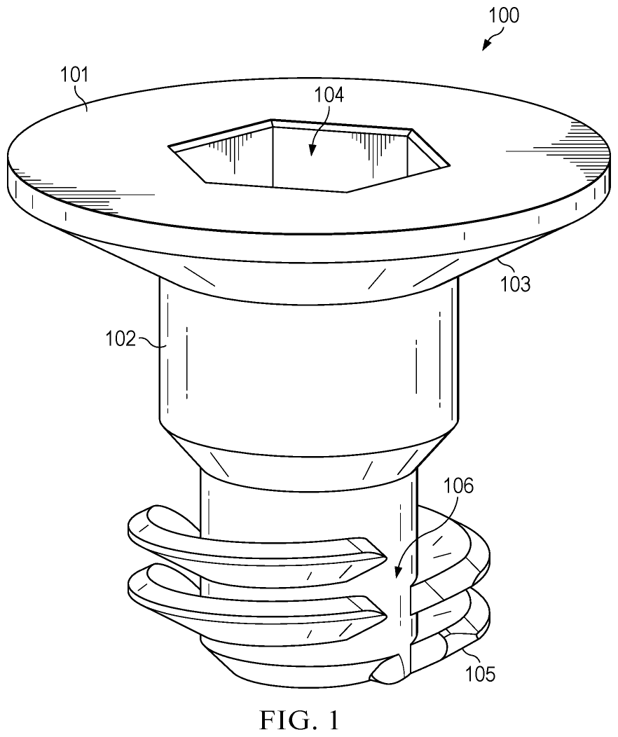

Preferred embodiments and their advantages are best understood by reference to FIGS. 1 through 3, wherein like numbers are used to indicate like and corresponding parts. For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For the purposes of this disclosure, information handling resources may broadly refer to any component system, device or apparatus of an information handling system, including without limitation processors, service processors, basic input/output systems, buses, memories, I/O devices and/or interfaces, storage resources, network interfaces, motherboards, and/or any other components and/or elements of an information handling system.

FIG. 1 illustrates a perspective view of an example screw 100 with tool-less installation features, in accordance with embodiments of the present disclosure. As shown in FIG. 1, screw 100 may comprise a substantially disc-shaped screw head 101 coupled to a substantially cylindrical shaft 102. In some embodiments, a bottom surface 103 of screw head 101 (e.g., the surface of screw head 101 adjacent to cylindrical shaft 102) may taper from an edge of screw head 101 to cylindrical shaft 102. A top surface of screw head 101 may include feature 104 for facilitating engagement of a tool head with screw head 101 (e.g., features for engaging with a flat-head screwdriver, a Phillips screwdriver, a hexagonal screwdriver, an Allen key, or other tool) to facilitate mechanical removal of screw 100 by such tool.

As further shown in FIG. 1, cylindrical shaft 102 may be partially threaded with a helical thread 105 (e.g., less than an entire length of cylindrical shaft 102 may be threaded with helical thread 105) to facilitate engagement of screw 100 with an appropriate countersink. Cylindrical shaft 102 may further comprise one or more discontinuities 106 in helical thread 105, such that helical thread 105 may sufficiently deform and reform to facilitate tool-less installation of screw 100 into the threaded insert (e.g., installation by application of a linear force to drive screw 100 into an appropriate threaded insert). Screw 100 may be formed from a compliant material. Examples of compliant material include, but are not limited to, soft plastic and soft rubber material. In some embodiments, flexibility of screw 100 upon installation may further depend on a stiffness of the compliant material. While FIG. 1 illustrates cylindrical shaft 102 as partially threaded, cylindrical shaft 102 may be fully threaded in other embodiments.

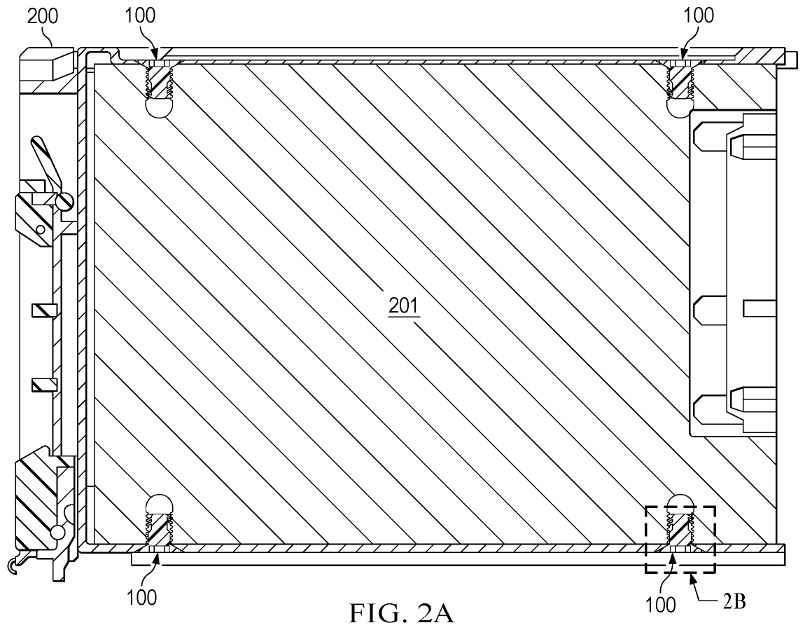

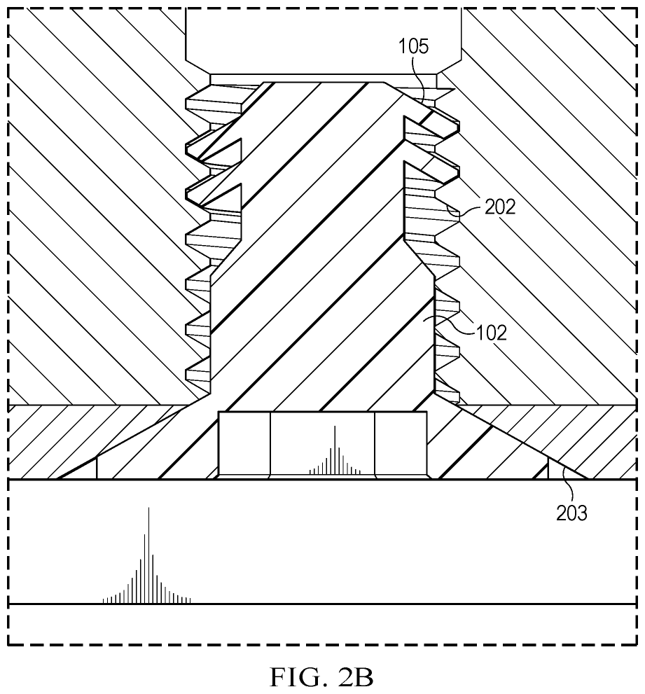

FIGS. 2A and 2B illustrate plan views of an example component carrier 200 including example screws 100 with tool-less installation features installed in the example component carrier 200, in accordance with embodiments of the present disclosure. As shown in FIGS. 2A and 2B, a component 201 may mechanically couple to component carrier 200 via screws 100. In some embodiments, helical thread 105 may engage with a thread of threaded insert 202, and a non-threaded portion of cylindrical shaft 102 may fit securely within threaded insert 202. In some embodiments, removal of screw 100 from threaded insert 202 may require use of a tool. While FIGS. 2A and 2B show threaded insert 202 comprising a countersink portion 203, it is to be understood that threaded insert 202 may comprise any portion suitable to accommodate screw head 101 (e.g., a counterbore portion) such that screw head 101 may sit flush against a surface of component carrier 200. In some embodiments, threaded insert 202 may not comprise a portion to accommodate screw head 101, such that screw head 101 may not sit flush against a surface of component carrier 200.

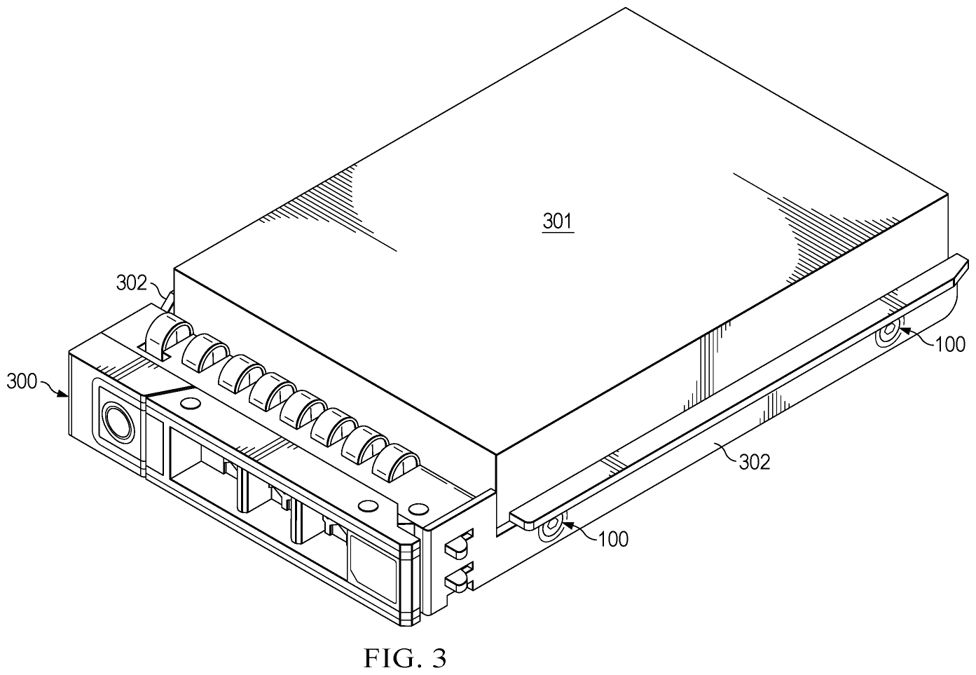

In operation, a linear force may be applied to screw 100 to drive screw 100 into threaded insert 202. Compliance of helical thread 105 may allow tool-less installation of screw 100 (e.g., application of the linear force may be applied by a human's fingers). Helical thread 105 may sufficiently deform upon insertion into threaded insert 202 due to mechanical interaction of helical thread 105 with the thread of threaded insert 202. Helical thread 105 may sufficiently reform to engage with the thread of threaded insert 202, and the non-threaded portion of cylindrical shaft 102 may securely fit within threaded insert 202. While installation of screw 101 may be accomplished without the use of a tool, removal of screw 101 may require a tool. FIG. 3 illustrates a perspective view of an example component carrier 300 mechanically coupled to an example component 301 via example screws 100, in accordance with embodiments of the present disclosure. As shown in FIG. 3, a component 301 may mechanically couple to component carrier 300 by screws 100 in carrier side walls 302.

Although the foregoing contemplates using screw 100 to mechanically fix a component (e.g., an information handling resource) to a component carrier, screw 100 as disclosed herein may be used in any other suitable application in which it is desired to mechanically couple one object to another using a screw or other fastener.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

What is claimed is:

1. A screw comprising:
a head; and
a threaded cylindrical shaft mechanically coupled to the head such that an axis of the threaded cylindrical shaft extends from the head, wherein the threaded cylindrical shaft comprises a helical thread configured to:
sufficiently deform when a mechanical force drives the screw into a threaded insert due to mechanical interaction of the helical thread with a thread of the threaded insert; and
sufficiently engage with the thread of the threaded insert.

2. The screw of claim 1, wherein the threaded cylindrical shaft is partially threaded.

3. The screw of claim 2, wherein a non-threaded portion of the partially threaded cylindrical shaft is configured to fit securely within the threaded insert.

4. The screw of claim 1, wherein the threaded cylindrical shaft further comprises at least one discontinuity in the helical thread.

5. The screw of claim 1, wherein a bottom surface of the screw head adjacent to the cylindrical shaft tapers from the edge of the screw head to the cylindrical shaft.

6. The screw of claim 1, wherein the driving mechanical force comprises applying a linear force to the screw.

7. The screw of claim 1, wherein a top surface of the head comprises at least one feature for facilitating engagement of a tool head to facilitate removal of the screw from the threaded insert.

8. An information handling system comprising:
an information handling resource;
a carrier configured to mechanically couple to the information handling resource; and
a screw for mechanically coupling the information handling resource to the carrier, the screw comprising:
a head; and
a threaded cylindrical shaft mechanically coupled to the head such that an axis of the threaded cylindrical shaft extends from the head, wherein the threaded cylindrical shaft comprises a helical thread configured to:
sufficiently deform when a mechanical force drives the screw into a threaded insert due to mechanical interaction of the helical thread with a thread of the threaded insert; and
sufficiently engage with the thread of the threaded insert.

9. The information handling system of claim 8, wherein the threaded cylindrical shaft is partially threaded.

10. The information handling system of claim 9, wherein a non-threaded portion of the partially threaded cylindrical shaft is configured to fit securely within the threaded insert.

11. The information handling system of claim 8, wherein the threaded cylindrical shaft further comprises at least one discontinuity in the helical thread.

12. The information handling system of claim 8, wherein a bottom surface of the screw head adjacent to the cylindrical shaft tapers from the edge of the screw head to the cylindrical shaft.

13. The information handling system of claim 8, wherein the driving mechanical force comprises applying a linear force to the screw.

14. The information handling system of claim 8, wherein a top surface of the head comprises at least one feature for facilitating engagement of a tool head to facilitate removal of the screw from the threaded insert.

15. A method comprising:
mechanically coupling a head of a screw to a threaded cylindrical shaft of the screw such that an axis of the threaded cylindrical shaft extends from the head, wherein the threaded cylindrical shaft comprises a helical thread configured to:
sufficiently deform when a mechanical force drives the screw into a threaded insert due to mechanical interaction of the helical thread with a thread of the threaded insert; and
sufficiently engage with the thread of the threaded insert.

16. The method of claim 15, wherein the threaded cylindrical shaft is partially threaded.

17. The method of claim 16, wherein a non-threaded portion of the partially threaded cylindrical shaft is configured to fit securely within the threaded insert.

18. The method of claim 15, wherein the threaded cylindrical shaft further comprises at least one discontinuity in the helical thread.

19. The method of claim 15, wherein a bottom surface of the screw head adjacent to the cylindrical shaft tapers from the edge of the screw head to the cylindrical shaft.

20. The method of claim 15, wherein the driving mechanical force comprises applying a linear force to the screw.

21. The method of claim 15, wherein a top surface of the head comprises at least one feature for facilitating engagement of a tool head to facilitate removal of the screw from the threaded insert.
